(19) United States
(12) Patent Application Publication
(10) Pub. No.: US 2025/0249900 A1
(43) Pub. Date: Aug. 7, 2025

(54) Lane Departure Monitoring Methods and Apparatuses

(71) Applicant: Robert Bosch GmbH, Stuttgart (DE)

(72) Inventors: Peng Ge, Suzhou (CN); Xiaowen Yang, Suzhou (CN)

(21) Appl. No.: 19/040,575

(22) Filed: Jan. 29, 2025

(30) Foreign Application Priority Data
Feb. 2, 2024 (CN) 2024 1015 3275.2

(51) Int. Cl. B60W 30/12; B60W 30/14; B60W 50/00; B60W 50/14; B60W 60/00

(52) U.S. Cl. CPC B60W 30/12; B60W 30/146; B60W 50/0097; B60W 50/14; B60W 60/0053; B60W 60/0057; B60W 2520/10; B60W 2520/125

(57) ABSTRACT

A lane departure monitoring method includes (i) calculating the lateral offset of the vehicle at the reaction time, (ii) predicting whether the vehicle will depart from the lane under the control of an autonomous or assisted driving system according to the calculated lateral offset, (iii) after predicting that the vehicle will depart from the lane, calculating the maximum lateral offset of the vehicle relative to the left lane line or the right lane line based on the lateral acceleration limit value and the lateral acceleration gradient limit value, (iv) again predicting whether the autonomous driving system or assisted driving system can control the vehicle within the lane according to the maximum lateral offset, and (v) based on the result of the second prediction, decelerating the vehicle and/or sending an alert signal to the driver. Also disclosed is a lane departure monitoring apparatus, computer-readable storage media, computer program products, and a domain controller for a vehicle.

This application claims priority under 35 U.S.C. § 119 to application no. CN 2024 1015 3275.2, filed on Feb. 2, 2024 in China, the disclosure of which is incorporated herein by reference in its entirety.

The present application relates to the field of lateral monitoring of vehicles, and more particularly, relates to lane departure monitoring methods and apparatuses, computer-readable storage media, computer program products, and domain controllers for a vehicle.

### BACKGROUND

For L2 level autonomous driving, the autonomous driving system or driver-assistance system should always provide lateral control to keep the vehicle within the lane. If the system is unable to control the vehicle within the lane, the system will issue an alert to the driver to take control.

However, there may be strong crosswinds, strong road disturbances, sharp bends, or other factors that interfere with lateral control when the autonomous driving system or driver-assistance system is running. In these extreme cases, the system may not be able to control the vehicle to remain within the lane without the intervention of the driver. Particularly for “hands-free” driver-assistance systems, since the driver's hands are not on the steering wheel, the driver still needs some time to place their hands on the steering wheel and some additional time to take over the vehicle when a takeover is required. If the alert is triggered too late, the driver may not be able to operate the vehicle in time to keep it within the lane to avoid collisions with other vehicles or objects. On the other hand, if the alert is triggered too early, the system is too sensitive, affecting its usability.

### SUMMARY

One or more examples of the present application provide for a lane departure monitoring scheme that takes into account the reaction time of the driver's takeover of the steering wheel in order to trigger an alert for the driver to promptly take over the vehicle when necessary (e.g., a visual and/or audible alert via a human-machine interface).

According to one aspect of the present application, a method for lane departure monitoring of vehicles is provided, wherein the method comprises: calculating the lateral offset d_{lat_react} of the vehicle at the reaction time t_{react}; predicting whether the vehicle will depart from the lane under the control of an autonomous or assisted driving system according to the calculated lateral offset d_{lat_react}; after predicting that the vehicle will depart from the lane, calculating the maximum lateral offset d_{lat_max} of the vehicle relative to the left lane line or the right lane line based on the lateral acceleration limit value aₗₐₜₗᵢₘᵢₜ and the lateral acceleration gradient limit value jₗₐₜₗᵢₘᵢₜ; again predicting whether the autonomous driving system or assisted driving system can control the vehicle within the lane according to the maximum lateral offset d_{lat_max}; and based on the result of the second prediction, decelerating the vehicle and/or sending an alert signal to the driver.

In addition to or in place of the solution described above, in the method described above, decelerating the vehicle and/or sending an alert signal to the driver based on the result of the second prediction comprises: decelerating the vehicle when the autonomous driving system or assisted driving system is able to control the vehicle within the lane; and when the autonomous driving system or assisted driving system is unable to control the vehicle within the lane, sending the driver the alert signal to request takeover while the vehicle is being decelerated.

As a supplement to or replacement of the above solution, in the above method, calculating the lateral offset d_{lat_react} of the vehicle at the reaction time t_{react} comprises calculating the lateral offset d_{lat_react} according to the following equation:

$${d}_{lat\_react} = {v}_{lat} * {t}_{react} + \frac{{a}_{actlat} * {t}_{react}^{2}}{2} ,$$

wherein vₗₐₜ represents the lateral speed of the vehicle, a_{actlat} represents the lateral acceleration of the vehicle, and t_{react} represents the reaction time at which the driver takes over the steering wheel control.

As a supplement to or replacement of the above solution, in the above method, predicting whether the vehicle will depart from the lane under the control of an autonomous or assisted driving system according to the calculated lateral offset d_{lat_react} comprises: when the following two inequalities are satisfied, it is predicted that the vehicle will not depart from its lane under the control of the autonomous driving system or assisted driving system:

$${d}_{lat \_ react} - \frac{w}{2} > {d}_{leftlatborder} , and {d}_{lat \_ react} + \frac{w}{2} < {d}_{rightlatborder} ,$$

wherein w is the width of the vehicle, d_{leftlatborder} represents the lateral offset of the reference point relative to the left lane line under the coordinate system of the vehicle, d_{rightlatborder} represents the lateral offset of the reference point relative to the right lane line under the coordinate system of the vehicle, and wherein the reference point refers to the point of the longitudinal distance from the vehicle in the direction of speed v_{long}*t_{react} and v_{long} is the longitudinal speed of the vehicle.

As a supplement to or replacement of the above solution, in the above method, after predicting that the vehicle will depart from the lane, calculating the maximum lateral offset d_{lat_max} of the vehicle relative to the left lane line or the right lane line based on the lateral acceleration limit value aₗₐₜₗᵢₘᵢₜ and the lateral acceleration gradient limit value jₗₐₜₗᵢₘᵢₜ comprises: calculating the maximum lateral offset d_{lat_max according to the following formula}: d_{lat_max}=∫∫₀^{t}^{_{react}}a(t)dt²+v_{long}*t_{react}, wherein vₗₐₜ represents the lateral speed of the vehicle and a(t) is determined according to the following equation:

$$a ( t ) = \{ \begin{matrix}{a}_{actlat} + j ( t ) * t , t < \frac{{a}_{latlimit} - {a}_{actlat}}{{j}_{latlimit}} \\ {a}_{latlimit} , t \geq \frac{{a}_{latlimit} - {a}_{actlat}}{{j}_{latlimit}}\end{matrix} ,$$

and wherein t represents the time, a_{actlat} represents the lateral acceleration of the vehicle, aₗₐₜₗᵢₘᵢₜ represents the lateral acceleration limit value of the vehicle, and jₗₐₜₗᵢₘᵢₜ represents the lateral acceleration gradient limit value and the lateral acceleration gradient j(t) is determined according to the following equation:

$$j ( t ) = \{ \begin{matrix}{j}_{latlimit} , t < \frac{{a}_{latlimit} - {a}_{actlat}}{{j}_{latlimit}} \\ 0 , t \geq \frac{{a}_{latlimit} - {a}_{actlat}}{{j}_{latlimit}}\end{matrix} .$$

As a supplement to or replacement of the above solution, in the above method, again predicting whether the autonomous driving system or assisted driving system can control the vehicle within the lane according to the maximum lateral offset d_{lat_max} comprises: When the following two inequalities are satisfied, it is predicted that the autonomous driving system or assisted driving system can control the vehicle within the lane:

$${d}_{lat \_ react} - \frac{w}{2} > {d}_{leftlatborder} ; and {d}_{lat \_ react} + \frac{w}{2} < {d}_{rightlatborder} ,$$

wherein w is the width of the vehicle, d_{leftlatborder} represents the lateral offset of the reference point relative to the left lane line under the coordinate system of the vehicle, d_{rightlatborder} represents the lateral offset of the reference point relative to the right lane line under the coordinate system of the vehicle, and wherein the reference point refers to the point of the longitudinal distance from the vehicle in the direction of speed v_{long}*t_{react} and v_{long} is the longitudinal speed of the vehicle.

According to another aspect of the present application, an apparatus for lane departure monitoring is provided, the apparatus comprising: A first computing device for calculating the lateral offset d_{lat_react} of the vehicle at the reaction time t_{react}; a first prediction device for predicting whether the vehicle will depart from the lane under the control of an autonomous or assisted driving system according to the calculated lateral offset d_{lat_react}; a second computing device for calculating the maximum lateral offset d_{lat_max} of the vehicle relative to the left lane line or the right lane line based on the lateral acceleration limit value aₗₐₜₗᵢₘᵢₜ and the lateral acceleration gradient limit value jₗₐₜₗᵢₘᵢₜ after predicting that the vehicle will depart from the lane; a second prediction device for again predicting whether the autonomous driving system or assisted driving system can control the vehicle within the lane according to the maximum lateral offset d_{lat_max}; and a control device for decelerating the vehicle and/or sending an alert signal to the driver based on the result of the second prediction.

As a supplement or alternative to the solution described above, in the above apparatus, the control device is configured to: decelerate the vehicle when the autonomous driving system or assisted driving system is able to control the vehicle within the lane; and when the autonomous driving system or assisted driving system is unable to control the vehicle within the lane, send the driver the alert signal to request takeover while the vehicle is being decelerated.

As a supplement or alternative to the solution described above, in the above apparatus, the first computing device is configured to calculate the lateral offset according to the following equation

$${d}_{lat \_ react} : {d}_{lat \_ react} = {v}_{lat} * {t}_{react} + \frac{{a}_{actlat} * {t}_{react}^{2}}{2} ,$$

wherein vₗₐₜ represents the lateral speed of the vehicle, a_{actlat} represents the lateral acceleration of the vehicle, and t_{react} represents the reaction time at which the driver takes over the steering wheel control.

As a supplement or alternative to the solution described above, in the above apparatus, the first prediction device is configured to: when the following two inequalities are satisfied, predict that the vehicle will not depart from its lane under the control of the autonomous driving system or assisted driving system:

$${d}_{lat \_ react} - \frac{w}{2} > {d}_{leftlatborder} : and {d}_{lat \_ react} + \frac{w}{2} < {d}_{rightlatborder} ,$$

wherein w is the width of the vehicle, d_{leftlatborder} represents the lateral offset of the reference point relative to the left lane line under the coordinate system of the vehicle, d_{rightlatborder} represents the lateral offset of the reference point relative to the right lane line under the coordinate system of the vehicle, and wherein the reference point refers to the point of the longitudinal distance from the vehicle in the direction of speed v_{long}*t_{react} and v_{long} is the longitudinal speed of the vehicle.

As a supplement or alternative to the solution described above, in the above apparatus, the second computing device is configured to calculate the maximum lateral offset d_{lat_max} according to the following equation: d_{lat_max}=∫∫₀^{t}^{_{react}}a(t)dt²+v_{long}*t_{react} wherein vₗₐₜ represents the lateral speed of the vehicle and a(t) is determined according to the following equation:

$$a ( t ) = \{ \begin{matrix}{a}_{actlat} + j ( t ) * t , t < \frac{{a}_{latlimit} - {a}_{actlat}}{{j}_{latlimit}} \\ {a}_{latlimit} , t \geq \frac{{a}_{latlimit} - {a}_{actlat}}{{j}_{latlimit}}\end{matrix} ,$$

and wherein t represents the time, a_{actlat} represents the lateral acceleration of the vehicle, aₗₐₜₗᵢₘᵢₜ represents the lateral acceleration limit value of the vehicle, and jₗₐₜₗᵢₘᵢₜ represents the lateral acceleration gradient limit value and the lateral acceleration gradient j(t) is determined according to the following equation:

$$j ( t ) = \{ \begin{matrix}{j}_{latlimit} , t < \frac{{a}_{latlimit} - {a}_{actlat}}{{j}_{latlimit}} \\ 0 , t \geq \frac{{a}_{latlimit} - {a}_{actlat}}{{j}_{latlimit}}\end{matrix} .$$

As a supplement or alternative to the solution described above, in the above apparatus, the second prediction device is configured to: When the following two inequalities are satisfied, predicting that the autonomous driving system or assisted driving system can control the vehicle within the lane:

$${d}_{lat \_ max} - \frac{w}{2} > {d}_{leftlatborder} ; and {d}_{lat \_ max} + \frac{w}{2} < {d}_{rightlatborder} ,$$

wherein w is the width of the vehicle, d_{leftlatborder} represents the lateral offset of the reference point relative to the left lane line under the coordinate system of the vehicle, d_{rightlatborder} represents the lateral offset of the reference point relative to the right lane line under the coordinate system of the vehicle, and wherein the reference point refers to the point of the longitudinal distance from the vehicle in the direction of speed v_{long}*t_{react} and v_{long} is the longitudinal speed of the vehicle.

According to yet another aspect of the present application, a computer-readable storage medium is provided, the medium comprises instructions, and the instructions, when running, perform the method as described above.

According to yet another aspect of the present application, a computer program product is provided, which comprises a computer program, and the computer program, when executed by the processor, implements the method as described above.

According to yet another aspect of the present application, a domain controller for a vehicle is provided, the domain controller comprising the lane departure monitoring device as described above.

The lane departure monitoring scheme of the present application takes into account the reaction time t_{react} of the driver taking over the steering wheel, calculates the lateral offset d_{lat_react} of the vehicle at the reaction time t_{react}, and makes a first prediction of whether the vehicle will depart from its own lane under the control of the autonomous driving system or assisted driving system based on the calculated lateral offset d_{lat_react}; if it is predicted the first time that the vehicle will depart from its own lane, the lane departure monitoring scheme of the present application does not trigger an alert immediately, but further calculates the maximum lateral offset d_{lat_max} of the vehicle relative to the left lane line or the right lane line based on the lateral acceleration limit value aₗₐₜₗᵢₘᵢₜ and the lateral acceleration gradient limit value jₗₐₜₗᵢₘᵢₜ and predicts again whether the autonomous driving system or assisted driving system can control the vehicle within its own lane based on the maximum lateral offset d_{lat_max}. Finally, based on the result of the second prediction, the vehicle is decelerated and/or an alert signal is sent to the driver. The solution ensures that the alert is triggered in time to allow the driver to take over while taking into account the reaction time t_{react} of the driver's takeover of the steering wheel; at the same time, the alert is triggered only when necessary to maximize the usability of the autonomous driving system or assisted driving system.

### BRIEF DESCRIPTION OF THE DRAWINGS

The foregoing and other objectives and advantages of the present application will become more fully apparent from the following detailed description taken in conjunction with the accompanying drawings, in which identical or similar elements are denoted by the same reference numerals.

FIG. 1 illustrates a schematic flow diagram of a lane departure monitoring method according to an example of the present application;

FIG. 2 illustrates a structural schematic diagram of a lane departure monitoring apparatus according to an example of the present application;

FIG. 3 illustrates a schematic diagram of a model for predicting if a vehicle will depart from the lane under the control of an autonomous driving system or assisted driving system according to an example of the present application; and

FIG. 4 illustrates a framework diagram of an ADAS system including a domain controller according to an example of the present application.

### DETAILED DESCRIPTION

In the following, a lane departure monitoring solution for vehicles according to various exemplary examples of the present application will be described in detail with reference to the accompanying drawings.

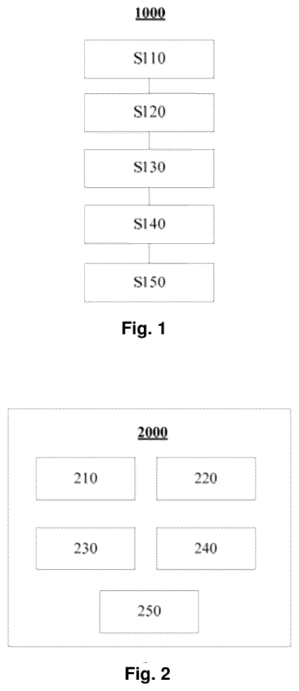

FIG. 1 illustrates a schematic flow diagram of a lane departure monitoring method 1000 according to an example of the present application. As shown in FIG. 1, the lane departure monitoring method 1000 comprises:
in step S110, calculating the lateral offset d_{lat_react} of the vehicle at the reaction time t_{react};
in step S120, predicting whether the vehicle will depart from the lane under the control of an autonomous or assisted driving system according to the calculated lateral offsetd_{lat_react};
in step S130, after predicting that the vehicle will depart from the lane, calculating the maximum lateral offset d_{lat_max} of the vehicle relative to the left lane line or the right lane line based on the lateral acceleration limit value aₗₐₜₗᵢₘᵢₜ and the lateral acceleration gradient limit value jₗₐₜₗᵢₘᵢₜ;
in step S140, again predicting whether the autonomous driving system or assisted driving system can control the vehicle within the lane according to the maximum lateral offset d_{lat_max}; and
in step S150, based on the result of the second prediction, decelerating the vehicle and/or sending an alert signal to the driver.

In the context of this application, the term “reaction time t_{react}” denotes the reaction time at which the driver is able to take over control of the steering wheel (or steering control), which is generally a fixed value.
In step S110, the lateral offset d_{lat_react} of the vehicle at the reaction time t_{react} is calculated. In one example, step S110 comprises: Calculating the lateral offset d_{lat_react} according to the following equation:

$${d}_{lat \_ react} = {v}_{lat} * {t}_{react} + \frac{{a}_{actlat} * {t}_{react}^{2}}{2} ,$$

wherein vₗₐₜ represents the lateral speed of the vehicle, a_{actlat} represents the lateral acceleration of the vehicle, and t_{react} represents the reaction time at which the driver takes over the steering wheel control. In this way, the calculated lateral offset d_{lat_react} represents the lateral offset that predicts the reaction time t_{react} under the coordinate system of the vehicle. The lateral offset (value) is symbolic, such as right positive and left negative; i.e., if it is predicted that the vehicle will be on the right side of the current position at the reaction time t_{react}, the lateral offset value is positive, while if it is predicted that the vehicle will be on the left side of the current position at the reaction time t_{react}, the lateral offset value is negative.
in step S120, whether the vehicle will depart from the lane under the control of an autonomous or assisted driving system is predicted according to the calculated lateral offsetd_{lat_react}. In one example, step S120 comprises: when the following two inequalities are satisfied, it is predicted that the vehicle will not depart from its lane under the control of the autonomous driving system or assisted driving system:

$${d}_{lat \_ react} - \frac{w}{2} > {d}_{leftlatborder} ; and {d}_{lat \_ react} + \frac{w}{2} < {d}_{rightlatborder} ,$$

wherein w is the width of the vehicle, d_{leftlatborder} represents the lateral offset of the reference point relative to the left lane line under the coordinate system of the vehicle, d_{rightlatborder} represents the lateral offset of the reference point relative to the right lane line under the coordinate system of the vehicle, and wherein the reference point refers to the point of the longitudinal distance from the vehicle in the direction of speed v_{long}*t_{react} and v_{long} is the longitudinal speed of the vehicle.

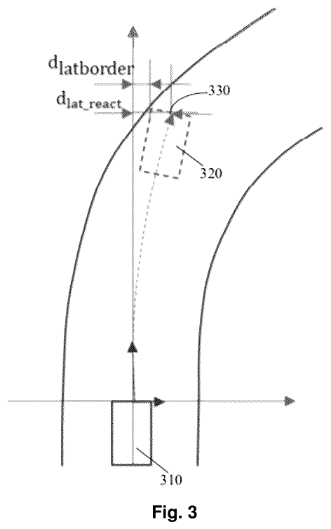

Referring to FIG. 3, it illustrates a schematic diagram of a model for predicting if a vehicle will depart from the lane under the control of an autonomous driving system or assisted driving system according to an example of the present application. For example, the present vehicle 310 is currently driving within a lane, the vehicle is in the position indicated by the dashed line 320 at the reaction t_{react}, and 330 indicates a reference point for calculating d_{leftlatborder} and d_{rightlatborder}. As shown in FIG. 3, the designation d_{lat_react} represents the lateral offset of this vehicle at the reaction time t_{react} and the designation d_{latborder} represents the (minimum) lateral offset of the reference point to the (left) lane line/boundary under the coordinate system of this vehicle.

For the left lane line, when the following inequality (1) is satisfied:

$${d}_{lat \_ react} - \frac{w}{2} > {d}_{leftlatborder} ,$$

it can be predicted that the vehicle will not depart from its own lane. While for the right lane line, when the following inequality (2) is satisfied:

$${d}_{lat \_ react} + \frac{w}{2} < {d}_{rightlatborder} ,$$

it can be predicted that the vehicle will not depart from its own lane.

As such, if it is predicted in step S120 that the vehicle will not depart from its lane under the control of an autonomous driving system or assisted driving system, the autonomous driving system or assisted driving system will continue to control the strategy without additional action.

Referring to step S130, after predicting that the vehicle will depart from the lane (e.g., none of the above inequalities (1) and (2) is established), the maximum lateral offset d_{lat_max} of the vehicle relative to the left lane line or the right lane line is calculated based on the lateral acceleration limit value aₗₐₜₗᵢₘᵢₜ and the lateral acceleration gradient limit value jₗₐₜₗᵢₘᵢₜ. In one example, step S130 comprises: calculating the maximum lateral offset d_{lat_max} according to the following formula:

$${d}_{lat \_ max} = \int {\int }_{0}^{{t}_{react}} a ( t ) {dt}^{2} + {v}_{lat} * {t}_{react} ,$$

wherein vₗₐₜ represents the lateral speed of the vehicle and a(t) is determined according to the following equation:

$$a ( t ) = \{ \begin{matrix}{a}_{actlat} + j ( t ) * t , t < \frac{{a}_{latlimit} - {a}_{actlat}}{{j}_{latlimit}} \\ {a}_{latlimit} , t \geq \frac{{a}_{latlimit} - {a}_{actlat}}{{j}_{latlimit}}\end{matrix} ,$$

and wherein t represents the time, a_{actlat} represents the lateral acceleration of the vehicle, □aₗₐₜₗᵢₘᵢₜ represents the lateral acceleration limit value of the vehicle, and □jₗₐₜₗᵢₘᵢₜ represents the lateral acceleration gradient limit value and the lateral acceleration gradient j(t) is determined according to the following equation:

$$j ( t ) = \{ \begin{matrix}{j}_{latlimit} , t < \frac{{a}_{latlimit} - {a}_{actlat}}{{j}_{latlimit}} \\ 0 , t \geq \frac{{a}_{latlimit} - {a}_{actlat}}{{j}_{latlimit}}\end{matrix} .$$

In one example, the lateral acceleration limit value aₗₐₜₗᵢₘᵢₜ of the vehicle and the lateral acceleration gradient limit value jₗₐₜₗᵢₘᵢₜ may be determined by an EPS steering torque limit value based on vehicle speed. In one example, the lateral acceleration a_{actlat} of the vehicle, the lateral acceleration limit value aₗₐₜₗᵢₘᵢₜ of the vehicle, and the lateral acceleration gradient limit value jₗₐₜₗᵢₘᵢₜ are all symbolized and are positive on the right and negative on the left under the vehicle coordinate system.

In step S140, whether the autonomous driving system or assisted driving system can control the vehicle within the lane is again predicted according to the maximum lateral offset d_{lat_max}. In one example, step S140 comprises: When the following two inequalities are satisfied, it is predicted that the autonomous driving system or assisted driving system can control the vehicle within the lane:

$${d}_{lat \_ react} - \frac{w}{2} > {d}_{leftlatborder} ; and {d}_{lat \_ react} + \frac{w}{2} < {d}_{rightlatborder} ,$$

wherein w is the width of the vehicle, d_{leftlatborder} represents the lateral offset of the reference point relative to the left lane line under the coordinate system of the vehicle, d_{rightlatborder} represents the lateral offset of the reference point relative to the right lane line under the coordinate system of the vehicle, and wherein the reference point refers to the point of the longitudinal distance from the vehicle in the direction of speed v_{long}*t_{react} and v_{long} is the longitudinal speed of the vehicle.

In step S150, based on the result of the second prediction, the vehicle is decelerated and/or an alert signal is sent to the driver. In one example, step S150 comprises: decelerating the vehicle when the autonomous driving system or assisted driving system is able to control the vehicle within the lane; and when the autonomous driving system or assisted driving system is unable to control the vehicle within the lane (e.g., this may be caused by strong road disturbance, strong crosswinds, or sharp bends) sending the driver the alert signal to request takeover while the vehicle is being decelerated. This enhances the maneuverability of the vehicle and helps it stay within its lane.

In one example, the alert is a visual and/or audible alert issued by a human-machine interface HMI. In one example, the decelerating speed of the vehicle is a comfortable decelerating speed (for the occupants).

Furthermore, it is easily understood by those skilled in the art that the lane departure monitoring method 1000 provided by one or more examples of the present application can be implemented by a computer program. For example, the computer program is contained in a computer program product, and when executed by a processor, implements the lane departure monitoring method 1000 of one or more examples of the present application. For instance, when a computer-readable storage medium (e.g., USB drive) containing the computer program is connected to a computer, running the computer program can implement one or more examples of the lane departure monitoring method 1000 of the present application.

Referring to FIG. 2, FIG. 2 illustrates a structural schematic diagram of a lane departure monitoring apparatus 2000 according to an example of the present application. As shown in FIG. 2, the lane departure monitoring device 2000 comprises: A first computing device 210, a first prediction device 220, a second computing device 230, a second prediction device 240, and a control device 250. Comprising a first computing device 210 for calculating the lateral offset d_{lat_react} of the vehicle at the reaction time t_{react}; a first prediction device 220 for predicting whether the vehicle will depart from the lane under the control of an autonomous or assisted driving system according to the calculated lateral offset d_{lat_react}; a second computing device 230 for calculating the maximum lateral offset d_{lat_max} of the vehicle relative to the left lane line or the right lane line based on the lateral acceleration limit value aₗₐₜₗᵢₘᵢₜ and the lateral acceleration gradient limit value jₗₐₜₗᵢₘᵢₜ after predicting that the vehicle will depart from the lane; a second prediction device 240 for again predicting whether the autonomous driving system or assisted driving system can control the vehicle within the lane according to the maximum lateral offset d_{lat_max}; and a control device 250 for decelerating the vehicle and/or sending an alert signal to the driver based on the result of the second prediction.

In one example, the control device 250 is configured to: decelerate the vehicle when the autonomous driving system or assisted driving system is able to control the vehicle within the lane; and when the autonomous driving system or assisted driving system is unable to control the vehicle within the lane, send the driver the alert signal to request takeover while the vehicle is being decelerated.

In one example, the first computing device 210 is configured to calculate the lateral offset

$${d}_{lat \_ react} : {d}_{lat \_ react} = {v}_{lat} * {t}_{react} + \frac{{a}_{actlat} * {t}_{react}^{2}}{2}$$

according to the following equation, wherein vₗₐₜ represents the lateral speed of the vehicle, a_{actlat} represents the lateral acceleration of the vehicle, and t_{react} represents the reaction time at which the driver takes over control of the steering wheel.

In one example, the first prediction device 220 is configured to: when the following two inequalities are satisfied, predict that the vehicle will not depart from its lane under the control of the autonomous driving system or assisted driving system:

$${d}_{lat \_ react} - \frac{w}{2} > {d}_{leftlatborder} ; and {d}_{lat \_ react} + \frac{w}{2} < {d}_{rightlatborder} ,$$

wherein w is the width of the vehicle, d_{leftlatborder} represents the lateral offset of the reference point relative to the left lane line under the coordinate system of the vehicle, d_{rightlatborder} represents the lateral offset of the reference point relative to the right lane line under the coordinate system of the vehicle, and wherein the reference point refers to the point of the longitudinal distance from the vehicle in the direction of speed v_{long}*t_{react} and v_{long} is the longitudinal speed of the vehicle.

In one example, the second computing device 230 is configured to calculate the maximum lateral offset d_{lat_max} according to the following equation: d_{lat_max}=∫∫₀^{t}^{_{react}}a(t)dt²+vₗₐₜ×t_{react}, wherein vₗₐₜ represents the lateral speed of the vehicle and a(t) is determined according to the following equation:

$$a ( t ) = \{ \begin{matrix}{a}_{actlat} + j ( t ) * t , t < \frac{{a}_{latlimit} - {a}_{actlat}}{{j}_{latlimit}} \\ {a}_{latlimit} , t \geq \frac{{a}_{latlimit} - {a}_{actlat}}{{j}_{latlimit}}\end{matrix} ,$$

and wherein t represents the time, a_{actlat} represents the lateral acceleration of the vehicle, aₗₐₜₗᵢₘᵢₜ represents the lateral acceleration limit value of the vehicle, and jₗₐₜₗᵢₘᵢₜ represents the lateral acceleration gradient limit value and the lateral acceleration gradient j(t) is determined according to the following equation:

$$j ( t ) = \{ \begin{matrix}{j}_{latlimit} , t < \frac{{a}_{latlimit} - {a}_{actlat}}{{j}_{latlimit}} \\ 0 , t \geq \frac{{a}_{latlimit} - {a}_{actlat}}{{j}_{latlimit}}\end{matrix} ∘$$

In one example, the second prediction device 240 is configured to: When the following two inequalities are satisfied, predict that the autonomous driving system or assisted driving system can control the vehicle within the lane:

$${d}_{lat\_max} - \frac{w}{2} > {d}_{leftlatborder} ; and {d}_{l at\_react} + \frac{w}{2} < {d}_{rightlatborder} ,$$

wherein w is the width of the vehicle, d_{leftlatborder} represents the lateral offset of the reference point relative to the left lane line under the coordinate system of the vehicle, d_{rightlatborder} represents the lateral offset of the reference point relative to the right lane line under the coordinate system of the vehicle, and wherein the reference point refers to the point of the longitudinal distance from the vehicle in the direction of speed v_{long}*t_{react} and v_{long} is the longitudinal speed of the vehicle.

The above lane departure monitoring device 2000 may be integrated in one or more examples within a domain controller in an autonomous driving system or assisted driving system (e.g., ADAS).

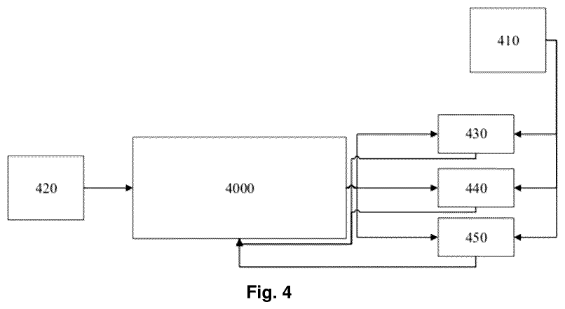

FIG. 4 illustrates a framework diagram of an ADAS system including a domain controller 4000 according to an example of the present application. As shown in FIG. 4, the domain controller 4000 receives a sensing signal from the sensor cluster 420 (which includes various types of lane-aware sensors) and processes the sensing signal so as to control the brake system 430 (longitudinal control), the powertrain 440 (longitudinal control), and the steering system 450 (lateral control), respectively. In addition, the brake system 430, the powertrain 440, and the steering system 450 also receive operational signals from the driver 410 and feed the dynamic state of the vehicle (wheel speed, lateral acceleration, steering wheel angle, etc.) and driver input (brake pedal state, throttle pedal position, etc.) back to the domain controller 4000.

In one example, the domain controller 4000 includes a perception module, a fusion module, a trajectory planning module, and a trajectory control module. The lane departure monitoring solution of this application may be implemented in a trajectory planning module as well as a trajectory control module.

In summary, the lane departure monitoring scheme of the present application takes into account the reaction time t_{react} of the driver taking over the steering wheel, calculates the lateral offset d_{lat_react} of the vehicle at the reaction time t_{react}, and makes a first prediction of whether the vehicle will depart from its own lane under the control of the autonomous driving system or assisted driving system based on the calculated lateral offset d_{lat_react}; if it is predicted the first time that the vehicle will depart from its own lane, the lane departure monitoring scheme of the present application does not trigger an alert immediately, but further calculates the maximum lateral offset d_{lat_max} of the vehicle relative to the left lane line or the right lane line based on the lateral acceleration limit value aₗₐₜₗᵢₘᵢₜ and the lateral acceleration gradient limit value jₗₐₜₗᵢₘᵢₜ and predicts again whether the autonomous driving system or assisted driving system can control the vehicle within its own lane based on the maximum lateral offset d_{lat_max}. Finally, based on the result of the second prediction, the vehicle is decelerated and/or an alert signal is sent to the driver. The solution ensures that the alert is triggered in time to allow the driver to take over while taking into account the reaction time t_{react} of the driver's takeover of the steering wheel; at the same time, the alert is triggered only when necessary to maximize the usability of the autonomous driving system or assisted driving system.

The above examples primarily illustrate the lane departure monitoring solution for vehicles of the examples of the present application. Although only some of the examples of the present application have been described, it should be understood by those with ordinary skill in the art that the present application may be implemented in various other forms without departing from its spirit and scope. Therefore, the examples and embodiments presented are illustrative rather than limiting, and the present application may encompass various modifications and replacements without departing from the spirit and scope defined by the various claims.

What is claimed is:

1. A lane departure monitoring method, comprising:
calculating a lateral offset d_{lat_react} of a vehicle at a reaction time t_{react};
predicting whether a vehicle will depart from a lane under control of an autonomous driving system or assisted driving system according to the calculated lateral offset d_{lat_react};
after predicting that the vehicle will depart from the lane, calculating a maximum lateral offset d_{lat_max} of the vehicle relative to a left lane line or a right lane line based on a lateral acceleration limit value aₗₐₜₗᵢₘᵢₜ and the lateral acceleration gradient limit value jₗₐₜₗᵢₘᵢₜ;
again predicting whether the autonomous driving system or assisted driving system can control the vehicle within the lane according to the maximum lateral offset d_{lat_max}; and
based on the result of the second prediction, decelerating the vehicle and/or sending an alert signal to the driver.

2. The method of claim 1, wherein decelerating the vehicle and/or sending the alert signal to the driver based on the result of the second prediction comprises:
decelerating the vehicle when the autonomous driving system or assisted driving system is able to control the vehicle within the lane; and
when the autonomous driving system or assisted driving system is unable to control the vehicle within the lane, sending the driver the alert signal to request takeover while the vehicle is being decelerated.

3. The method of claim 1, wherein calculating the lateral offset d_{lat_react} of the vehicle at the reaction time t_{react} comprises calculating the lateral offset d_{lat_react} according to the following equation:
$${d}_{lat\_react} = {v}_{lat} * {t}_{react} + \frac{{a}_{actlat} * {t}_{react}^{2}}{2} ,$$
wherein vₗₐₜ represents a lateral speed of the vehicle, a_{actlat} represents a lateral acceleration of the vehicle, and t_{react} represents the reaction time at which the driver takes over the steering wheel control.

4. The method of claim 1, wherein predicting whether the vehicle will depart from the lane under the control of the autonomous driving system or assisted driving system according to the calculated lateral offset d_{lat_react} comprises:
when the following two inequalities are satisfied, predicting that the vehicle will not depart from its lane under the control of the autonomous driving system or assisted driving system:
$${d}_{lat\_react} - \frac{w}{2} > {d}_{leftlatborder} ; and$$
$${d}_{lat\_react} + \frac{w}{2} < {d}_{rightlatborder} ,$$
wherein w is a width of the vehicle, d_{leftlatborder} represents the lateral offset of a reference point relative to the left lane line under a coordinate system of the vehicle, d_{rightlatborder} represents the lateral offset of the reference point relative to the right lane line under the coordinate system of the vehicle, and wherein the reference point refers to the point of a longitudinal distance from the vehicle in a direction of speed v_{long}*t_{react}, and v_{long} is a longitudinal speed of the vehicle.

5. The method of claim 1, wherein after predicting that the vehicle will depart from the lane, calculating the maximum lateral offset d_{lat_max} of the vehicle relative to the left lane line or the right lane line based on the lateral acceleration limit value aₗₐₜₗᵢₘᵢₜ and the lateral acceleration gradient limit value jₗₐₜₗᵢₘᵢₜ comprises:
calculating the maximum lateral offset d_{lat_max} according to the following formula:
$${d}_{lat\_max} = \int {\int }_{0}^{{t}_{react}} a ( t ) {dt}^{2} + {v}_{lat} * {t}_{react} .$$
wherein vₗₐₜ represents the lateral speed of the vehicle, and a(t) is determined according to the following equation:
$$a ( t ) = \{ \begin{matrix}{a}_{actlat} + j ( t ) * t , t < \frac{{a}_{latlimit} - {a}_{actlat}}{{j}_{latlimit}} \\ {a}_{latlimit} , t \geq \frac{{a}_{latlimit} - {a}_{actlat}}{{f}_{latlimit}}\end{matrix} ,$$
and wherein t represents the time, a_{actlat} represents the lateral acceleration of the vehicle, aₗₐₜₗᵢₘᵢₜ represents the lateral acceleration limit value of the vehicle, and jₗₐₜₗᵢₘᵢₜ represents the lateral acceleration gradient limit value, and the lateral acceleration gradient j(t) is determined according to the following equation:
$$j ( t ) = \{ \begin{matrix}{j}_{latlimit} , t < \frac{{a}_{latlimit} - {a}_{actlat}}{{f}_{latlimit}} \\ 0 , t \geq \frac{{a}_{latlimit} - {a}_{actlat}}{{f}_{latlimit}}\end{matrix} ∘ .$$

6. The method of claim 1, wherein again predicting whether the autonomous driving system or assisted driving system can control the vehicle within the lane according to the maximum lateral offset d_{lat_max} comprises:
when the following two inequalities are satisfied, predicting that the autonomous driving system or assisted driving system can control the vehicle within the lane:
$${d}_{lat\_max} - \frac{w}{2} > {d}_{leftlatborder} ; and$$
$${d}_{lat\_max} + \frac{w}{2} < {d}_{rightlatborder} ,$$
wherein w is a width of the vehicle, d_{leftlatborder} represents the lateral offset of a reference point relative to the left lane line under a coordinate system of the vehicle, d_{rightlatborder} represents the lateral offset of the reference point relative to the right lane line under the coordinate system of the vehicle, and wherein the reference point refers to the point of a longitudinal distance from the vehicle in a direction of speed v_{long}*t_{react}, and v_{long} is a longitudinal speed of the vehicle.

7. A device for lane departure monitoring of vehicles, comprising:
a first computing device configured to calculate a lateral offset d_{lat_react} of a vehicle at a reaction time t_{react};
a first prediction device configured to predict whether the vehicle will depart from the lane under the control of an autonomous or assisted driving system according to the calculated lateral offset d_{lat_react};
a second computing device configured to calculate a maximum lateral offset d_{lat_max} of the vehicle relative to a left lane line or a right lane line based on a lateral acceleration limit value aₗₐₜₗᵢₘᵢₜ and a lateral acceleration gradient limit value jₗₐₜₗᵢₘᵢₜ after predicting that the vehicle will depart from the lane;
a second prediction device configured to again predict whether the autonomous driving system or assisted driving system can control the vehicle within the lane according to the maximum lateral offset d_{lat_max}; and
a control device configured to decelerate the vehicle and/or send an alert signal to the driver based on the result of the second prediction.

8. The apparatus according to claim 7, wherein the control device is configured to:
decelerate the vehicle when the autonomous driving system or assisted driving system is able to control the vehicle within the lane; and
when the autonomous driving system or assisted driving system is unable to control the vehicle within the lane, send the driver the alert signal to request takeover while the vehicle is being decelerated.

9. The apparatus of claim 7, wherein the first computing device is configured to calculate the lateral offset d_{lat_react} according to the following equation:
$${d}_{lat\_react} = {v}_{lat} * {t}_{react} + \frac{{a}_{actlat} * {t}_{react}^{2}}{2} ,$$
wherein vₗₐₜ represents a lateral speed of the vehicle, a_{actlat} represents a lateral acceleration of the vehicle, and t_{react} represents the reaction time at which the driver takes over the steering wheel control.

10. The apparatus according to claim 7, wherein the first prediction device is configured to:
when the following two inequalities are satisfied, predict that the vehicle will not depart from its lane under the control of the autonomous driving system or assisted driving system:
$${d}_{lat\_react} - \frac{w}{2} > {d}_{leftlatborder} ; and$$
$${d}_{lat\_react} + \frac{w}{2} < {d}_{rightlatborder} ,$$
wherein w is a width of the vehicle, d_{leftlatborder} represents the lateral offset of a reference point relative to the left lane line under a coordinate system of the vehicle, d_{rightlatborder} represents the lateral offset of the reference point relative to the right lane line under the coordinate system of the vehicle, and wherein the reference point refers to the point of a longitudinal distance from the vehicle in a direction of speed v_{long}*t_{react}, and v_{long} is a longitudinal speed of the vehicle.

11. The apparatus of claim 7, wherein the second computing device is configured to calculate the maximum lateral offset d_{lat_max} according to the following equation:
$${d}_{lat\_max} = \int {\int }_{0}^{{t}_{react}} a ( t ) {dt}^{2} + {v}_{lat} * {t}_{react} ,$$
wherein vₗₐₜ represents the lateral speed of the vehicle, and a(t) is determined according to the following equation:
$$a ( t ) = \vert \{ \begin{matrix}{a}_{actlat} + j ( t ) * t , t < \frac{{a}_{latlimit} - {a}_{actlat}}{{j}_{latlimit}} \\ {a}_{latlimit} , t \geq \frac{{a}_{latlimit} - {a}_{actlat}}{{f}_{latlimit}}\end{matrix} ,$$
and wherein t represents the time, a_{actlat} represents a lateral acceleration of the vehicle, aₗₐₜₗᵢₘᵢₜ represents the lateral acceleration limit value of the vehicle, and jₗₐₜₗᵢₘᵢₜ represents the lateral acceleration gradient limit value, and the lateral acceleration gradient j(t) is determined according to the following equation:
$$j ( t ) = \{ \begin{matrix}{j}_{latlimit} , t < \frac{{a}_{latlimit} - {a}_{actlat}}{{f}_{latlimit}} \\ 0 , t \geq \frac{{a}_{latlimit} - {a}_{actlat}}{{f}_{latlimit}}\end{matrix} ∘ .$$

12. The apparatus according to claim 7, wherein the second prediction device is configured to:
when the following two inequalities are satisfied, predict that the autonomous driving system or assisted driving system can control the vehicle within the lane:
$${d}_{lat\_max} - \frac{w}{2} > {d}_{leftlatborder} ; and$$
$${d}_{lat\_max} + \frac{w}{2} < {d}_{rightlatborder} ,$$
wherein w is a width of the vehicle, d_{leftlatborder} represents the lateral offset of a reference point relative to the left lane line under a coordinate system of the vehicle, d_{rightlatborder} represents the lateral offset of the reference point relative to the right lane line under the coordinate system of the vehicle, and wherein the reference point refers to the point of a longitudinal distance from the vehicle in a direction of speed v_{long}*t_{react}, and v_{long} is a longitudinal speed of the vehicle.

13. A computer-readable storage medium, wherein the medium comprises instructions that, when executed, perform the method according to claim 1.

14. A computer program product, comprising a computer program, wherein the computer program, when executed by a processor, implements the method according to claim 1.

15. A domain controller for a vehicle, wherein the domain controller includes a lane departure monitoring apparatus according to claim 7.
